(19) United States
(12) Patent Application Publication
(10) Pub. No.: US 2010/0058538 A1
(43) Pub. Date: Mar. 11, 2010

(54) Baby headrest

(76) Inventor: Michael Rieber, Livingston, NJ (US)

Correspondence Address: GEARHART LAW, LLC, 4 FERNDALE ROAD, CHATHAM, NJ, 07928, US

(21) Appl. No.: 12/584,524

(22) Filed: Sep. 8, 2009

Related U.S. Application Data
(60) Provisional application No. 61/095,349, filed on Sep. 9, 2008.

(51) Int. Cl. A47G 9/10; A47D 15/00; A47C 20/02; A47C 7/38; B60N 2/48

(52) U.S. Cl. 5/644; 5/636; 297/397

(57) ABSTRACT

The resent invention is a baby headrest device, having a sleeve having a flat top surface and a bottom surface with the inner cavity of the sleeve being filled with a cushioning material, and the sleeve having a maximum dimension of from about 3 inches to about 12 inches and between about 1 inch and about 4 inches thick. The sleeve would have a specialized cover to protect from dirt and damage. Such cover would further contain an opening for the sleeve, and would have a closing mechanism for said opening.

### CLAIM OF PRIORITY

This application claims the priority of U.S. Ser. No. 61/095,349 filed on Sep. 9, 2008, the contents of which are fully incorporated herein by reference.

### FIELD OF THE INVENTION

The invention relates to infant care, more precisely, to a head cushion for an infant or toddler.

### BACKGROUND OF THE INVENTION

The present invention discloses a headrest for an infant or toddler having a gel filled sleeve. The filling provides cushioning and support, while keeping the size and thickness of the invention to a minimum. Doctors suggest that babies need some form of head support to maintain a supine position. This position helps keeps the air paths unobstructed, thus reducing the chances of Sudden Infant Death Syndrome (SIDS). Until now, the headrests available were inadequate, bulky or contained contours around a baby's head, to prevent a “flat head” condition. These contours did not account for a baby's restless nature, and any shift of position by an infant would diminish the benefit of special contours and cutouts. The present invention is a vast improvement over prior art, since the headrest is thin enough for use by an infant, small enough to be placed in any crib or a child car seat, and soft enough to prevent flat headedness, as well as eliminating the need for head supporting contours.

Known prior art headrests include U.S. Pat. No. 6,052,820; U.S. Pat. No. 6,321,403; U.S. Pat. No. 6,536,058; and U.S. Patent Application No. 20060096031.

U.S. Pat. No. 6,052,820 discloses a support device for newborns, including premature babies, comprising a doughnut-shaped structure having a gel-filled GORE-TEX casing of about five to six inches outer diameter with a central aperture of about two to three inches in diameter. The structure provides an annular tube having about a 1 to 2 inch diameter. The tube is preferably circular in cross-section at the rear or head region and preferably flattened to provide a generally oval cross-section at the front or neck region. The case is filled with a cohesive gel mass such as silicone gel or silicone elastomers with sufficiently cross-linked polysiloxane networks to substantially retain a selected shape despite the force of a limited incident weight.

U.S. Pat. No. 6,321,403 discloses a support pillow for supporting a head or a person when in a supine position comprises a cushion member having a support region at least partially surrounding a pressure relief region. The support region is configured to support at least a portion of a head, and the pressure relief region is configured to receive at least a portion of a back side of the head such that pressure applied to the back side of the head is reduced when lying in a supine position.

The U.S. Pat. No. 6,536,058 describes a headrest device for holding the neck and head of infants to assist the development of the shape of their skull. The device includes a base, the outside contour of which is concave for holding the head and designed according to the measurement of the average of different head shapes of normal newborn babies. A depressed segment of the base is used to support the infant's typically weak neck. A removable supplement and a direct-contact piece are included as well in this headrest device.

The U.S. Patent Application No. 20060096031 discloses A baby sleeping cushion and method of use thereof, wherein the cushion is wedge-shaped and comprises two principal layers, a top layer and a bottom layer. The bottom high-density foam provides a firm backing or support and the selected elevation from head end to foot end. The viscoelastic or visio memory foam top layer molds to the body form of a baby, retarding lateral movement of the baby, and preventing the baby from rolling from side-to-side. In addition to the two-layer wedge-shaped cushion, a separate cushioning device, generally hemispherical in shape, is removably secured to the wedge-shaped cushion, and supports the baby's legs and buttocks; thereby preventing movement of the baby in response to the inclined slope of the wedge-shaped cushion. An additional embodiment provides a support pillow to restrain the baby's head from movement removably-secured to the wedge-shaped cushion.

All of the patents above disclose specialized contraptions that address a specific problem in the art of baby headrests. The present invention, however, aims to remedy all of the problems with a single solution by using a specialized gel filling made from Akton®, which is a polymer that is soft yet supportive, providing a comfortable level of elevation for babies and toddlers. Nor does the present invention require specialized grooves and cutouts to prevent a “flat head” condition since the filler and the overall shape and size of the invention will provide ample support in spots where it is needed most.

One embodiment of this invention is illustrated in the accompanying drawings and will be described in more detail herein below.

### SUMMARY OF THE INVENTION

The invention is an article of manufacture, more particularly, a baby headrest, having a sleeve with a flat top surface and a bottom surface, the sleeve being filled with a cushioning material with a dimension from about 3 inches to about 12 inches in diameter and between about 1 inch and about 4 inches thick.

It is an object of the present invention to provide a baby and toddler headrest.

It is an object of the present invention to provide a headrest which would be thin, light, tear resistant, stain resistant, non-flammable, and hypoallergenic.

It is an object of the present invention to provide a headrest that will not be easily displaced by the toddler, by having a frictional surface.

It is an object of the present invention to provide a headrest to potentially reduce occurrences of a Sudden Infant Death Syndrome (SIDS).

It is an object of the present invention to provide a headrest to prevent “flat head” condition that is caused by prolonged lying in a supine position.

It is an object of the present invention to provide a headrest filled with Akton® polymer.

It is an object of the present invention to provide a headrest that has a removable pouch that is made of supple material.

It is an object of the present invention to provide a pouch that contains an opening to admit a headrest, and said opening having a closing mechanism.

It is an object of the present invention to provide a baby and toddler headrest for a car seat.

### BRIEF DESCRIPTION OF THE DRAWINGS

FIG. 1 is a side view of the preferred function of the present invention, showing a child using the cushion as a headrest while lying in a supine position.

FIG. 2 is a side view of the preferred embodiment of the invention, showing a sleeve, its top and bottom surfaces and a side seam.

FIG. 3 is a top view of the preferred embodiment of the invention, showing a top surface and a side seam.

FIG. 4 is a bottom view of the preferred embodiment of the invention, showing a bottom surface and a side seam.

FIG. 5 is a side view of an alternative embodiment without a side seam.

FIG. 6 is a perspective view with a cross section, showing a top and bottom surfaces, a side seam and an inner cavity.

FIG. 7 is a side view of the present invention, shown encased in a pouch. The pouch for the present invention showing an opening with a closing mechanism, as well as top and bottom pouch covers.

FIG. 8 is a side view of a pouch for the present invention showing an opening with a closing mechanism, a top pouch cover, and a bottom pouch cover.

FIG. 9 is a view of the present invention being used in a child's car seat.

### DESCRIPTION OF THE PREFERRED EMBODIMENTS

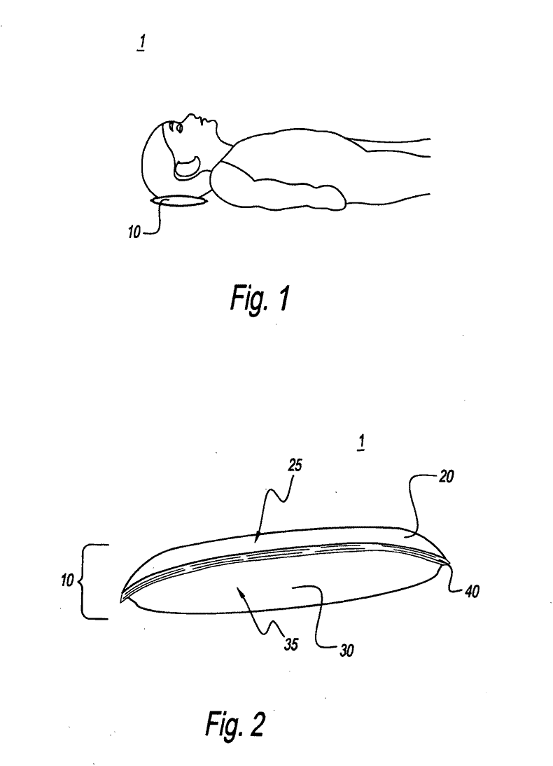

The preferred embodiments of the present invention will now be described with reference to FIG. 1-9 of the drawings. Identical elements in the various figures are identified with the same reference numerals.

The invention discloses a headrest for infants and toddlers that can be used anywhere a child sleeps or lies down, including but not limited to, in cribs, bassinets, child car seats, changing tables, especially flip down flip tables at public restrooms, rockers and high chairs. As will be described later, the present invention may contain Velcro style hooks, elastic strips or non-elastic bands so that the device may be easily and securely affixed to an upright surface, a flat substantially smooth or slippery surface, or any cloth covered surface. FIG. 1 shows a cushion 1 with sleeve 10 being used by an infant or toddler to maintain proper posture or for comfort. Notice that a child this young cannot comfortably or safely use a conventional pillow due to its thickness. Despite the thinness of the present invention the sleeve 10 is still able to have enough room for indentation of the top surface when pressed upon by a child's head. The thickness of the sleeve may range from ¼ inch to 4″ inches, with a preferred thickness from one to four inches. The diameter of the sleeve may range from 3 to 12 inches with a preferred diameter of about 6 inches.

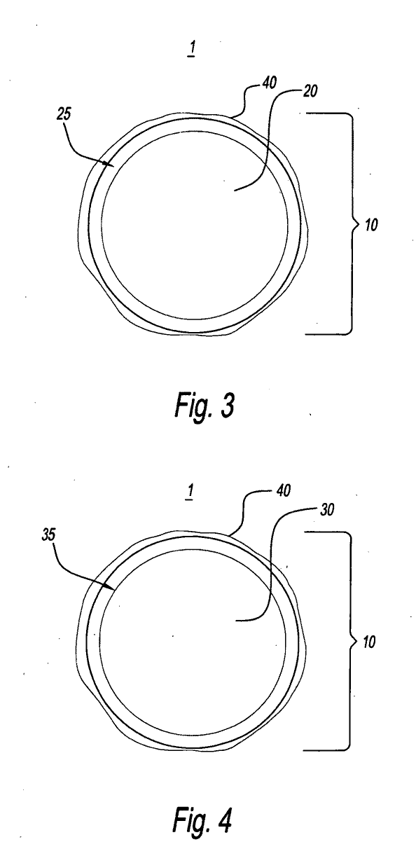

The sleeve 10 may have a cover 60 (FIG. 3) which has a top and bottom and an opening and a closing mechanism, with the dimensions of the cover 60 substantially conforming to the dimensions of the sleeve. The cover 60 may be made from a soft material and may contain frictionally adherent components, such as described in the discussion of FIGS. 3 and 4. The cover may be removable or integral to the sleeve 10, as an added layer of protection for containing the cushioning material inside. The cover or the bare sleeve 10 may be any color, and may contain material suitable for disposing indicia, or other matter, including but not limited to, figures, pictures, advertising, logos, designs, or patterns.

FIG. 2 is a side view of the preferred embodiment showing a cushion 1 with a sleeve 10, the sleeve 10 having a top surface 20, a top section 25, a bottom surface 30, a bottom section 35, and a side seam 40. The top surface 20 and the bottom surface 30 would be manufactured from separate sections of material 25 and 35, and attached together at the side seam 40. The preferred embodiment specifies the presence of the of the side seam 40 since it would function as a strengthening member by preventing deformation, tearing, and undue stretching. A side seam 40 is also a typically required by the manufacturing process for items of this type, as it is generally easier to manufacture several simple segments of material and fuse, weld or stamp them together, than it is to shape a piece of raw material into a final product. The seam could be made by a number of methods, including but not limited to, stitching, gluing, cramping, fusing, stamping or welding, or in any other way that would create a hermetical, and durable linkage, and would also conform with any code or legal requirements for items of this nature. Alternatively, the top surface 20 and the bottom surface 30 may be manufactured as a single unit obviating the need for the side seam 40. The preferred width of the side seam 40 should be no greater then 1/16 to ¼ of an inch. However, in a seamless embodiment, it may be desirable to impregnate the sleeve 10 with armature made of diagonal or interlaced fibers of a tough durable material, such as polymeric or fine metallic fiber. A framework created out of fine fibers would provide a desired level of structural integrity, while not compromising the flexibility of the present invention.

FIG. 3 and FIG. 4 disclose the top and the bottom views respectively of the preferred embodiment of the present invention. Shown are a cushion 1 with a sleeve 10, a top surface 20, a top section 25, a bottom surface 30, a bottom section 35, and a side seam 40. Either section 25 or 35 may be manufactured from frictional material such as but not limited to, rubber, plastic, fiber, any combination of these or other materials, or any composite material, or some other material containing increased frictional coefficient. Alternatively, the top or bottom surfaces 20 and 30 need not be frictional but may have frictional elements disposed thereon. For example, in an embodiment where the bottom surface 30 is made of cloth, a frictional element would likely be a rubber strip, multiple strips, or a plurality of interconnected strips that form a design and may be pasted or stuck onto the bottom surface 30. The frictional elements may cover the entire surface or any portion thereof. The frictional elements may be random or may be disposed in patterns, caricatures, figures, indicia, or any other desired design. The frictional elements may be any color, and may all be the same color or may be varying colors. In an ideal embodiment, the material used should be strong enough to resist tearing through rough handling, or as a result of being bitten, and at the same time be easy to disinfect and be resistant to staining. The increased friction is desirable to help keep the present invention in one place without using fastening means such as straps, snap fasteners or hook and loop fasteners. Alternatively, straps, hook and loop connectors, or snap fastener connectors can be disposed on the bottom surface 30 by default, or as required, such as in cases were friction alone will no longer hold the sleeve 10 from shifting or falling. Additionally, the bottom surface 30 may contain an elastic band (not shown) stretching from one side of the seam 40, across the bottom surface 30 to the opposite side of the seam 40, or it may be a non-elastic band disposed in a similar fashion. This type of a band may then be mounted onto a supporting surface by first pulling it away from the bottom surface 30 and then by wrapping it around a back or bottom of a chair or a top surface, or around a narrow structural element, such as an arm rest, or wrapped around some other support surface. The present invention may utilize Velcro type hooks that would latch onto cloth covered surfaces.

Still referring to FIG. 3 and FIG. 4, the shape shown is substantially round or circular. The shape can also be square, rectangular, octagonal, or take a shape of a figure or in any other shape that still enables the present invention to fulfill its purpose as a headrest. Although shown as the same in the figures, the top and bottom surfaces 20 and 30 of the sleeve 10 or of a cover 60 may be different from each other, in means including but not limited to, surface texture, color, presence of or type of indicia, pictures, figures, designs, and patterns, or even in size, shape, or material. For instance, the sleeve or cover may be blue with a teddy bear design on the top surface, while the bottom surface is pink with a ballerina design. Alternatively, the sleeve 10 may be in the shape of a teddy bear on the top surface while the bottom surface may be round, or the entire sleeve may be in shape of a teddy bear or other shape.

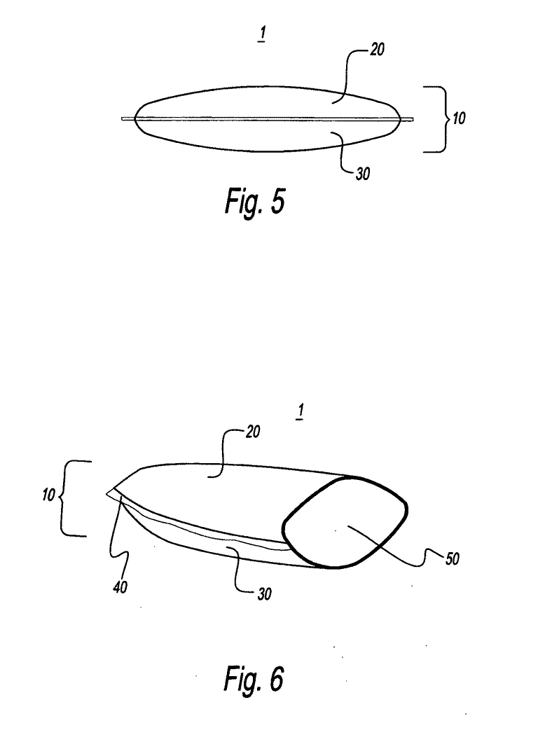

As mentioned above, the top surface 20 and the bottom surface 30 can instead be formed to be one monolithic unit, thus eliminating the side seam 40. In FIG. 5, which is a side view of the present invention, showing a sleeve 10, a top surface 20 and a bottom surface 30, the side seam 40 is absent. This may be done for aesthetic considerations or to increase the flexibility of the sleeve 10. With or without the side seam 40, the present invention is highly flexible and can be deformed or folded for storage, for insertion into a protective covering or it can take the shape of the supporting surface underneath. Since this invention is very flexible and soft, there is no danger of property damage or damage to limbs if a child decides to use the invention as a toy.

FIG. 6 is a perspective cross sectional view of the preferred invention. Visible are cushion 1, a sleeve 10, a top surface 20, a bottom surface 30, a side seam 40, and inner cavity 50. In a preferred embodiment, the inner cavity may be partially or completely filled with a flowing gel-like substance, such as but not limited to, an Acton® polymer. An ideal filler, such as Acton®, would be hypoallergenic and will not leak, flow, or bottom out. Acton® polymer is also generally known for its fire retarding qualities and as being resistant to microbiological growth. The Acton® polymer would be the preferred filler since it does not cause pressure sores after prolonged usage. Alternatively any deformable substance, including but not limited to, a gel-like substance or even foam, cotton padding, liquid or fine sand can be used as filler. The cross section view of the preferred invention discloses it as being somewhat oval and substantially flat. Such a shape provides maximum utility and traction for a typical device embodied by the present invention.

In an alternative embodiment, the sleeve 10 may include an air pocket (not shown), which may additionally be adjustable. An air pocket would supplement the cushioning ability of a filler substance. An air pocket may have an external air volume adjustment pump, which may be operated manually or with an electronic mechanism. An electronically operated mechanism may additionally contain a receiver from a remote control device that would remotely signal for deflation or inflation of the internal air pocket. The air pocket additionally would provide an ability to easily adjust the surface temperature of the present invention, since the air within the air pocket may be heated or cooled prior to being impelled into the air pocket. The air pocket would be completely encased by the filler material and by sleeve 10.

Various other alternative embodiments of the present invention are also possible. For example the filler may be impregnated with various objects, such as toys or marbles, which may additionally function as bells and produce jingle noise when shaken. This would increase the fun factor of the invention, and may therefore be a desirable feature.

The sleeve 10 may also be made more intelligent and enhanced with monitoring capabilities. For example, the top surface 20 or the bottom surface 30 may contain temperature sensors that may display the child's body temperature either on a local liquid crystal or digital screen, or be able to send the temperature data remotely via a wireless transmitter to a remote receiver of a device that monitors and interprets such data. Additional sensors may measure the infants' brain activity or weight of the head, such as, but not limited to sensors that detect neurological signals within the brain, or sensors that dynamically tract the differences in weight over time. A minutest change in neurological activity or in the weight of the head may signal that a child is in distress or that there is a presence of fluids in the cranial cavity. The wireless and sensory technology is well known in the art of medical monitoring equipment. Therefore, a person skilled in this art would be able to appreciate how this technology may be integrated with the present invention.

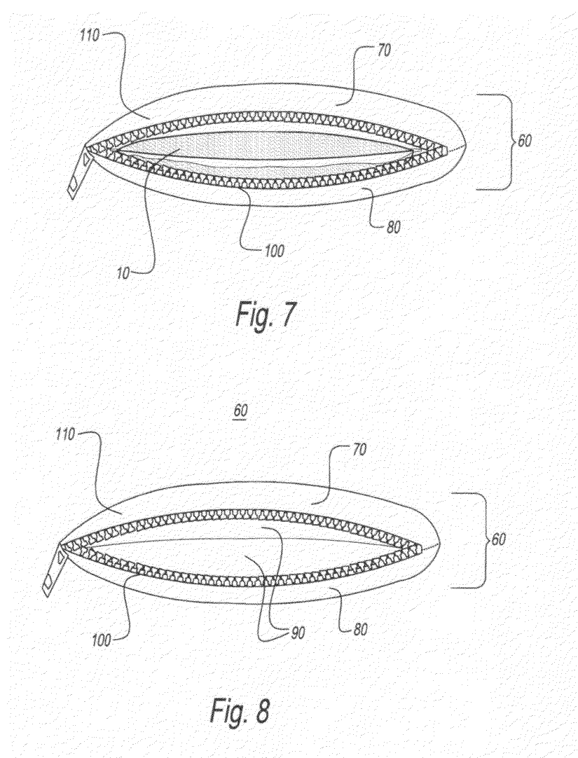

FIG. 7 is a side view of the cushion 1 with the sleeve 10 submerged within a protective pouch. The sleeve 10 is deformable and is filled with cushioning material. Visible in FIG. 7 are a sleeve 10, a pouch 60, a pouch top cover 70, a pouch bottom cover 80, an opening 100, and a closing mechanism 110. The opening 100 would be wide enough for easy insertion and egression of the sleeve 10. The pouch 60 would be tight enough to minimize slippage between the sleeve 10 and the pouch 60, which may be decreased further by frictional qualities of the top surface 20 and bottom surface 30 (not shown) of the sleeve 10. The slippage is not desirable since a child's head needs to be preferably placed in the middle of the top surface 20 for optimum utility. Any slippage would shift the position of the head toward the edges of the present invention, and thus diminish or hamper the utility of the present invention. The pouch bottom cover 80 may be made out of frictional material, such as but not limited to, rubber, plastic, resin or a polymer, or have multiple frictional elements disposed on it.

Still referring to FIG. 7, the pouch 60, in an ideal embodiment, would be manufactured from a non-flammable, easy to clean, durable, stain resistant, and stretchable fabric. The fabric would be supple and gentle to the touch. The main purpose of the pouch 60 is to provide increased protection to the sleeve 10 against dirt and damage. It can serve to increase the softness of the present invention and thus be more pleasing to a child. It is also more hygienically preferable to use the sleeve 10 together with the pouch 60, since the latter can be easily be replaced with a clean pouch 60, while the soiled pouch 60 is cleaned and disinfected. Inexpensive and temporary covers may be used in medicinal settings, where disposability is desired. The pouch may be made from any suitable material, including but not limited to, fabric, leather, plastic, rubber, glass, paper, wood, metal, or any combination of these or other materials. Minky is an especially preferred material for the pouch.

The pouch 60 may be made from material suitable for printing or adding decals, including but not limited to, textured materials, indicia, pictures, figures, designs, and patterns. Any color or combination of colors may be used for the above, and the pouch itself may be any material or color or combination of materials and colors. The pouch 60 may additionally contain exterior or interior pockets (not shown).

Although shown as the same in the figures, the top and bottom surfaces of the sleeve 10 or of the pouch 60 may be different from each other, in means including but not limited to, surface texture, color, presence and/or type of indicia, pictures, figures, designs, and patterns, or even in size, shape, or material.

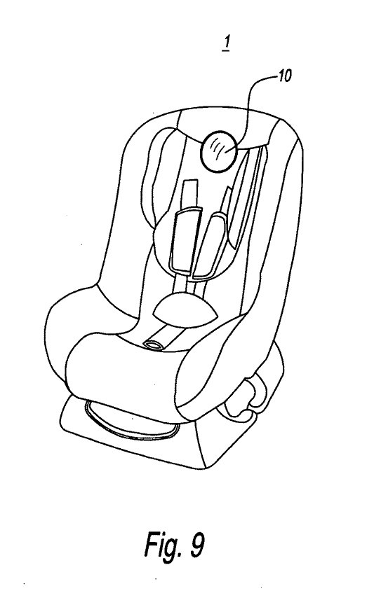

FIG. 8 is a side view of the pouch 60 without the inner sleeve 10. Also visible are a top cover 70, a bottom cover 80, an inside surface 90, an opening 100, and a closing mechanism 110. In a preferred embodiment, the inside surface 90 of the pouch 60 would be smooth and without protrusions that can damage the sleeve 10. In FIG. 8, zip fasteners are implemented as the closing mechanism 110 for the opening 100. Alternatively, the opening 100 can be held closed by a variety of means, including but not limited to, with elongated flaps, loops and lace, hook and loop fasteners, snaps, or be crumpled shut with a draw cord, a channel and rail fastener, as well as coil or invisible zipper.

FIG. 9 is another location where the present invention would serve as a headrest. The small size, durability and stain resistance of the present invention would make it very versatile and suitable to use in many locations. Pictured in FIG. 9 is a cushion 1 with a sleeve 10 adhered on a child's car seat. As shown, the sleeve 10 is disposed frictionally, without any kind of fastening. The slant of the car seat's back and the weight of a child's head would generally prevent the invention from shifting or falling down. However, if a more secure attachment is desired, the sleeve 10 can be attached to the back of a car seat by a variety of means, including but not limited to, using glue, straps, buttons, snap fasteners, or hook and loop fasteners. The present invention may similarly be useful with rockers, high chairs, or diaper changing tables, especially flip-down tables at public restrooms.

The invention would preferably be used in cribs and car seats to provide a headrest for infants and toddlers. Doctors advise that infants and small children should be placed in cribs in a supine position. This position helps keep breathing passages clear, reducing the chances of a Sudden Infant Death Syndrome (SIDS). However, continuous lying in a supine position is likely to lead to the back of the head becoming flat.

The present invention would prevent the head from becoming flat by employing a soft fluid substance, such as a gel, or a viscoelastic polymer, such as Acton® polymer, as a cushioning material. First, an infant's head would begin to exert pressure onto the top surface 20 of the sleeve 10, which would compress the filler and push it to the edges of the inner cavity. This would create a condition where the middle of the sleeve 10, where the pressure is greatest, would have developed an indentation that contours around the outline of the back of an infant's head, while the sides all around the indentation, would now be denser and more supportive. Thus, the center of the rear portion of the head would be permitted to sink into the headrest, while the perimeter around the back of the head would get an extra degree of support by the filler material that got pushed aside while the head was sinking into the sleeve 10. Eventually, the depressing force would equal the upward pressure of the filler and the sinking would cease, leaving the head in an elevated, but supported position, while minimizing the pressure on the back of the head. Gel-like filler would not need to be especially thick to enable this functionality. Nor is a thick head support desired, since it would not be very comfortable and would pose an increased risk of SIDS to a child who may inadvertently roll off or chose to turn over from the back to the stomach, and would thus end up burying his or her face within a cushion or bed sheets.

Although this invention has been described as primarily for use with infants and toddlers, it may also have applications in geriatric or invalid care. For instance, the cushion could be used to alleviate the pressure that causes bedsores, or it could be used to decrease pain from resting tender body parts on a surface. It may also be used to cushion or assuage injuries, or to temper ordinarily hard areas such as insides of helmets or soles of shoes. The pouch 60 may be made of a disposable material, so that the present invention may have medicinal or other application in a hygienic even sterile manner, the sleeve 10 being shared between users, but protected from contamination by an individualized or disposable pouch.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. A baby headrest, comprising:
a sleeve having a flat top surface and a bottom surface;
the sleeve being filled with a cushioning material; and
the sleeve having a dimension of from about 3 inches to about 12 inches in diameter and between about 1 inch and about 4 inches thick.

2. The headrest of claim 1, wherein the top surface and bottom surface is made out of tear resistant material.

3. The headrest of claim 1, wherein the cushioning material is a gel.

4. The headrest of claim 1, wherein the cushioning material is a viscoelastic polymer.

5. The headrest of claim 1, wherein the sleeve is substantially deformable.

6. The headrest of claim 1, wherein the sleeve is substantially round.

7. The headrest of claim 1, wherein the sleeve is square.

8. The headrest of claim 1, further comprising a cover for the sleeve;
the cover having a top and a bottom and an opening;
the opening having a closing mechanism; and
the sleeve substantially fitting within the cover.

9. The headrest of claim 8, wherein the cover is made out of soft fabric.

10. The headrest of claim 9, wherein the closing mechanism contains hook and loop fasteners.

11. The headrest of claim 8, wherein the sleeve frictionally adheres the headrest to a car seat.

12. The headrest of claim 8, wherein the headrest is disposed in a baby's crib.

13. The headrest of claim 8, wherein the closing mechanism contains zip fasteners.

14. The headrest of claim 8, wherein the top and bottom surfaces are made out of stain resistant material.

15. A headrest comprising:
a pouch with at least one opening;
the opening containing a closing mechanism;
the opening permits an insertion of a head support apparatus;
the head support apparatus is a sleeve;
the sleeve is filled with a cushioning material;
the sleeve having a dimension from 3 inches to 12 inches in diameter and between 1 inch and 4 inches thick; and
the sleeve substantially fits within the pouch.

16. A method of supporting a head of an infant comprising the steps of:
disposing a headrest in a crib or on a car seat, wherein the headrest comprises:
a substantially flat sleeve; and
a cushioning material within the sleeve.

17. The method of claim 16, further comprising a pouch for the sleeve.
